(19) United States
(12) Patent Application Publication
(10) Pub. No.: US 2019/0246071 A1
(43) Pub. Date: Aug. 8, 2019

(54) Building Monitoring System

(71) Applicants: Nancy H. Chen, North Andover, MA (US); Barry Stout, Beverly, MA (US)

(72) Inventors: Nancy H. Chen, North Andover, MA (US); Barry Stout, Beverly, MA (US)

(73) Assignee: OSRAM SYLVANIA Inc., Wilmington, MA (US)

(21) Appl. No.: 15/891,338

(22) Filed: Feb. 7, 2018

(51) Int. Cl. H04N 7/18; G10L 25/51; H04N 5/247; G06K 9/00; G06K 9/32; G06K 7/14; G06K 7/10

(52) U.S. Cl. CPC H04N 7/181; G10L 25/51; H04N 5/247; G06K 7/10722; H04N 7/185; G06K 9/32; G06K 7/1417; G06K 9/00771

(57) ABSTRACT

A building monitoring system includes a plurality of image capture devices deployed to obtain images of target building systems, the target building systems being associated with optical landmarks visible by the image capture devices. A plurality of audio beacons are configured to output audio landmarks. A plurality of audio capture devices are deployed to obtain sound clips of the target building systems, each sound clip of the target building systems including at least one of the audio landmarks from the audio beacons. A data analysis system is configured to receive the images of the target building systems and identify each target building system from at least one of the optical landmarks and the audio landmarks.

### TECHNICAL FIELD

This present application relates to building monitoring systems.

### BACKGROUND

Buildings often have numerous systems that require periodic monitoring. There is thus a growing interest in making buildings smarter through gathering and analyzing various forms of building data, including occupancy, environmental conditions, and equipment operation. New building equipment products are likely to include Internet of Things (IoT) technology to facilitate data gathering, but existing installed building equipment may still have many years of useful life and therefore not be replaced for many years. Retrofitting or adding new IoT enabled meters to old equipment is an option, but may also be costly or difficult, especially for smaller buildings and/or organizations with lower capital budgets.

### SUMMARY

All examples and features mentioned below may be combined in any technically possible way.

In some implementations disclosed herein, a building monitoring system includes a plurality of image capture devices deployed to obtain images of target building systems, the target building systems being associated with optical landmarks visible by the image capture devices, a plurality of audio beacons configured to output audio landmarks, a plurality of audio capture devices deployed to obtain sound clips of the target building systems, each sound clip of the target building systems including at least one of the audio landmarks from the plurality of audio beacons, and a data analysis system configured to receive the images of the target building systems, receive the sound clips of the target building systems, and identify each of the target building systems using at least one of the optical landmarks and the audio landmarks.

In some embodiments, the plurality of image capture devices are fixed relative to the target building systems. In some embodiments, the optical landmarks are bar codes or Quick Response (QR) codes. In some embodiments, the audio landmarks are audio signatures in a frequency range above approximately 20 kHz to be outside a human audible frequency range.

In some embodiments, the system further including a mobile audio and video capture device configured to obtain images of the target building systems and optical landmarks, and configured to obtain sound clips of the target building systems and the audio beacons. In some embodiments, the data analysis system is further configured to receive the images and sound clips from the mobile audio and video capture device and sort the images from the mobile audio and video capture device using the optical landmarks, and to sort the sound clips from the mobile audio and video capture device using the audio landmarks.

In some embodiments, the system further includes a mobile device executing a building monitoring system application configured to specify a new target building system to be monitored by the building monitoring system. In some embodiments, the building monitoring system application is configured to specify the new target building system by acquiring a test image of the new target building system to be monitored, determining whether image properties of the test image are satisfactory, and determining whether one of the optical landmarks is visible in the test image. In some embodiments, the building monitoring system application is configured to specify the new target building system by receiving user input including characterizing information about the new target building system to be monitored. In some embodiments, the building monitoring system application is configured to specify the new target building system by acquiring a test sound clip of the new target building system to be monitored, determining whether audio properties of the test sound clip are satisfactory, and determining whether one of the audio landmarks is audible in the test sound clip.

In some embodiments, the data analysis system is further configured to analyze the images for an anomaly in the operation of the target building systems, and in response to detecting an anomaly in the operation of a first target building system, instruct a first image capture device in the plurality of image capture devices to obtain additional images of the first target building system. In some embodiments, the data analysis system is further configured to analyze the sound clips for an anomaly in the operation of the target building systems, and in response to detecting an anomaly in the operation of a first target building system, instruct a first audio capture device in the plurality of audio capture devices to obtain additional sound clips of the first target building system. In some embodiments, the data analysis system is further configured to analyze the images for an anomaly in the operation of the target building systems, and in response to detecting an anomaly in the operation of a first target building system, instruct a first audio capture device in the plurality of audio capture devices to obtain additional sound clips of the first target building system. In some embodiments, the data analysis system is further configured to analyze the sound clips for an anomaly in the operation of the target building systems, and in response to detecting an anomaly in the operation of a first target building system, instruct a first image capture device in the plurality of image capture devices to obtain additional images of the first target building system. In some embodiments, the data analysis system is further configured to analyze the images for an anomaly in the operation of the target building systems, and in response to detecting an anomaly in the operation of a first target building system, instruct a mobile audio and video capture device to obtain a sound clip of the first target building system or to obtain additional images of the first target building system. In some embodiments, the data analysis system is further configured to analyze the sound clips for an anomaly in the operation of the target building systems, and in response to detecting an anomaly in the operation of a first target building system, instruct a mobile audio and video capture device to obtain a sound clip of the first target building system or to obtain additional images of the first target building system.

In some embodiments, at least one of the image capture devices and at least one of the audio capture devices are configured to cooperatively collect a video clip, and the data analysis system is further configured to receive the video clip and sort the video clip by detecting one of the optical landmarks or one of the audio landmarks in the video clip. In some embodiments, when the video clip includes one of the optical landmarks, the data analysis system is further configured to extract images and sound from the video clip and sort the images and sound using the optical landmark, and when the video clip includes one of the audio landmarks, the data analysis system is configured to extract images and sound from the video clip and sort the images and sound using the audio landmark.

In further implementations disclosed herein, a method of building monitoring may include receiving an image of a target building system from an image capture device, the image including a picture of the target building system and an optical landmark associated with the target building system, identifying the target building system from the optical landmark, extracting information about a first monitored aspect of the target building system from the image of the target building system, and comparing the extracted information about the first monitored aspect of the target building system with previously extracted information about the first monitored aspect of the target building system from previously received images of the target building system.

In some embodiments, the method further includes receiving a sound clip of the target building system from an audio capture device, the sound clip including sound produced by the target building system and an audio landmark from an audio beacon proximate the target building system, extracting information about a second monitored aspect of the target building system from the sound clip of the target building system, and comparing the extracted information about the second monitored aspect of the target building system with previously extracted information about the second monitored aspect of the target building system from previously received sound clips of the target building system.

### BRIEF DESCRIPTION OF THE DRAWINGS

FIG. 1 is a floor plan diagram of an example building in which a building monitoring system is deployed in accordance with some embodiments of the present disclosure.

FIGS. 2-4 are block diagrams showing examples of data collection in a building monitoring system in accordance with some embodiments of the present disclosure.

FIGS. 5-6 are functional block diagrams of networked components of a building monitoring system in accordance with some embodiments of the present disclosure.

FIGS. 7-13 are flow charts of example methods implemented in accordance with some embodiments of the present disclosure.

FIGS. 14-16 are block diagrams of aspects of an example application for interacting with an example building monitoring system in accordance with some embodiments of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing.

### DETAILED DESCRIPTION

This disclosure is based, at least in part, on the realization that it would be advantageous to provide a building monitoring system configured to collect and analyze data associated with target building systems without requiring the target building systems to be retrofitted with new network connected sensors and gauges. Numerous configurations and variations will be apparent in light of this disclosure.

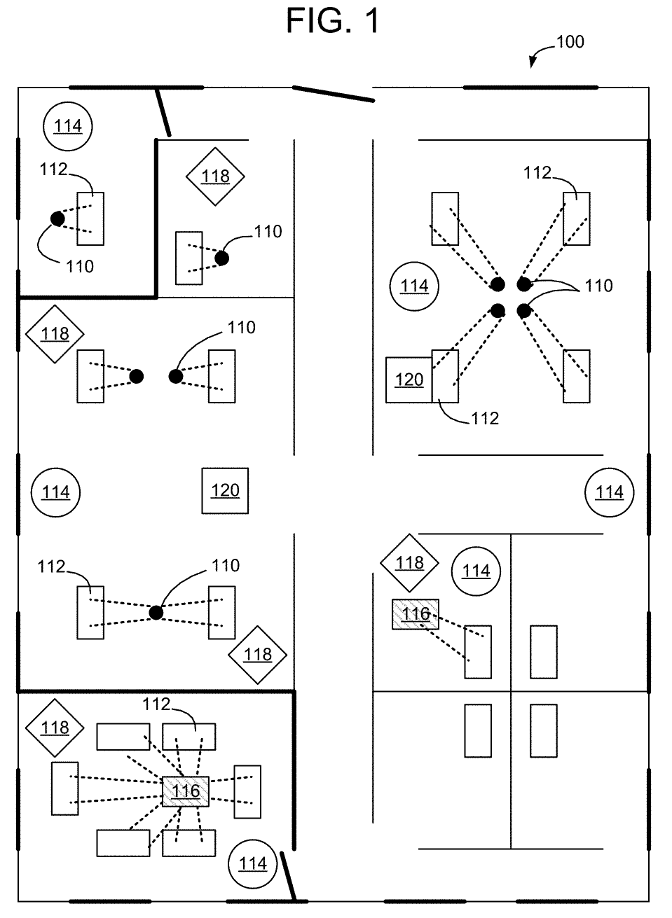

FIG. 1 is a floor plan diagram of an example building in which a building monitoring system 100 is deployed, in accordance with some embodiments of the present disclosure. In the example building shown in FIG. 1, the building monitoring system 100 includes a plurality of image capture devices 110 for capturing images of target building systems 112, and a plurality of audio capture devices 114 for capturing audio from the target building systems 112. The building monitoring system 100 also includes one or more mobile audio and video capture devices 116, and a plurality of audio beacons 118. In some embodiments, the building monitoring system 100 also includes other sensors, such as temperature sensors 120.

In some embodiments, the building monitoring system 100 includes a collection of cameras, microphones, and other sensors that are installed in the building to collect data for the building monitoring system 100. In some embodiments, the data collected by the image capture devices 110, audio capture devices 114, mobile audio and video capture devices 116, and temperature sensors 120, includes images of equipment panels and dial values, general images of an open office, sound clips of machinery or alarms, stockroom inventory images, ambient temperature readings, and other information that may be used to assess the operating conditions of target building systems 112.

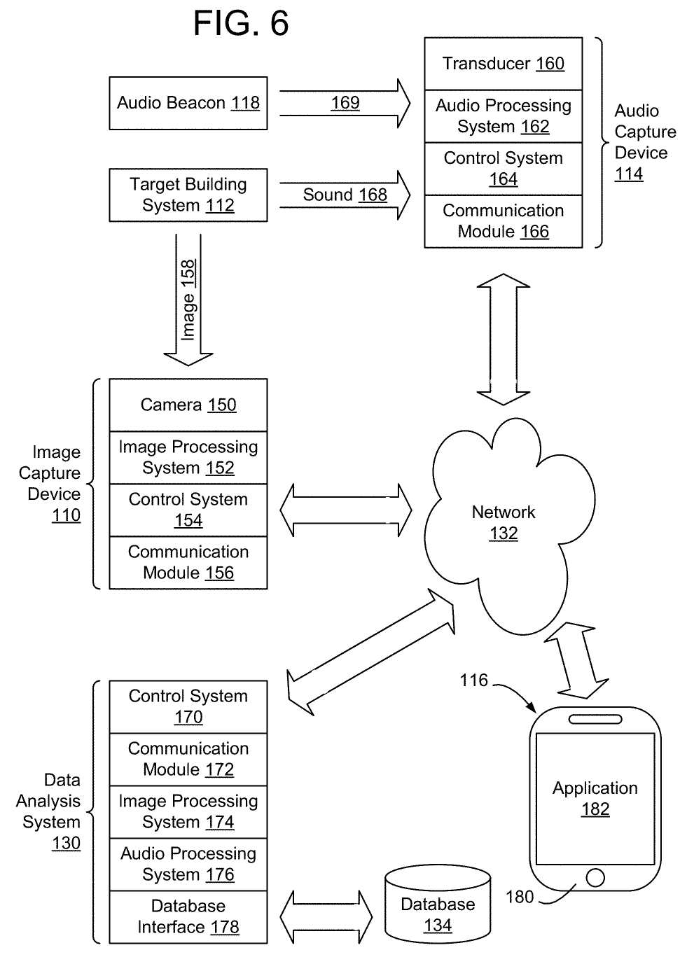

In some embodiments, the mobile audio and video capture device 116 is a smartphone, tablet, laptop computer, or other portable handheld device 180 running a building monitoring system application 182 (see FIG. 6) that enables manual gathering of images and sound clips by patrolling personnel such as security guards or robots.

Images, sound clips, and other data are uploaded to a data analysis system 130, such as a cloud based computer platform, for storage, retrieval, and analysis. In some embodiments cloud-based computer analysis of images and sound clips is used to extract numerical values from images of meters and dials, assess stockroom inventory from images of storage shelves, estimate occupancy levels, detect cleanliness, detect water leaks, detect unusual machine operation or alarms sounding, and detect other conditions within the building. Detected conditions may trigger notifications to the customer. In some embodiments, plots of the digitized data are created and data analytics are applied to the collected data to show trends over time.

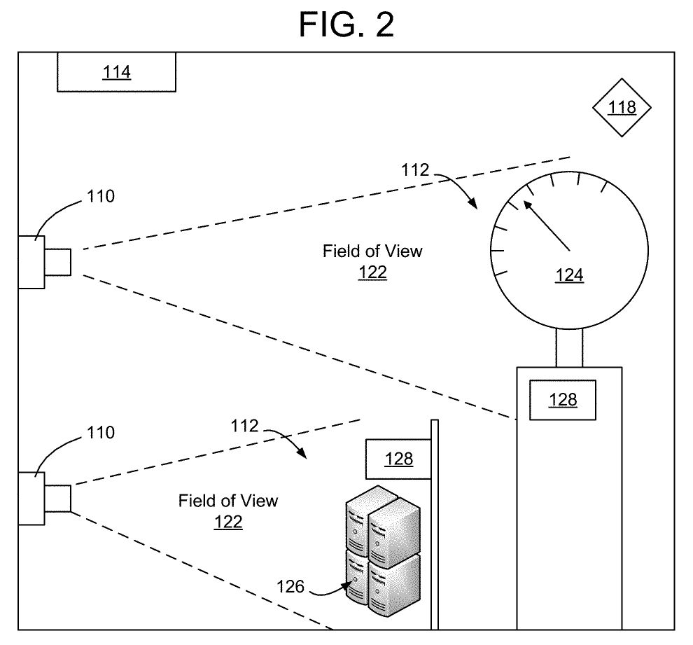

FIGS. 2-4 are block diagrams showing examples of data collection in a building monitoring system in accordance with some embodiments of the present disclosure. As shown in FIG. 2, in some embodiments an image capture device 110 is implemented as a camera fixed relative to a target building system 112 such that the image capture device 110 has at least an aspect of the target building system 112 within its field of view 122. Images captured by the image capture device 110 includes one or more digital or analog dials 124, a display panel 126 such as an electronic display of computer equipment or a display showing meter readings or status indicators, or other types of sensor output displays that may be visually interpreted.

In some implementations one or more optical landmarks 128 are provided within the field of view 122 of the image capture device 110. Example optical landmarks 128 include one dimensional bar codes, two-dimensional matrix codes such as a Quick Response (QR) codes, or other graphics designed to encode data.

In some implementations, the optical landmark 128 is physically placed proximate the target building system 112. For example, in some embodiments the optical landmark 128 is placed proximate the target building system 112 to be within the field of view 122 of the image capture device 110, so that images acquired by the image capture device 110 include the optical landmark 128. Likewise, images captured by mobile audio and video capture device 116 also include the optical landmark 128 as well as the target building system 112. By including optical landmarks 128 in images of the target building system 112, the data analysis system 130 may determine which target building system 112 is shown in the image without requiring the data analysis system 130 to know which device created the image.

Audio capture device 114, in some implementations, is implemented as a microphone fixed within audio range of the target building system 112 such that the audio capture device 114 may detect sounds produced by the target building system 112. In some implementations, the audio capture device 114 periodically samples audio to obtain a sound clip of an environment including the target building system 112. The sound clip may be used to determine if the target building system 112 is operating normally or is operating abnormally and making a sound other than normal. The sound clip may also be used to detect if the target building system 112 is outputting a warning or alarm sound.

In some embodiments, audio beacon 118 outputs an audio landmark 169 that is detected by the audio capture device 114 and included in the sound clip produced by the audio capture device 114. The audio landmark 169 is used by the data analysis system 130 to identify a location where the sound clip originated without requiring the data analysis system 130 to know which audio capture device 114 created the sound clip.

In some embodiments, mobile audio and video capture device 116 or a combined image capture device 110 and audio capture device 114 is configured to obtain video clips containing both audio and video information. In some embodiments, the video clips contain either an optical landmark 128, an audio landmark 169, or both.

For video clips that include only an optical landmark 128, the data analysis system 130 uses the optical landmark 128 to identify the target building system 112. Optionally, in some embodiments, the data analysis system 130 extracts a still image from the video clip and sorts the still image using the optical landmark 128. In some embodiments, the data analysis system 130 extracts sound from the video clip and sorts the sound using the optical landmark 128. In some embodiments, the data analysis system 130 sorts the video clip using the optical landmark 128 and stores the video clip in database 134.

For video clips that include only an audio landmark 169, the data analysis system 130 uses the audio landmark 169 to identify the target building system 112. Optionally, in some embodiments, the data analysis system 130 extracts a still image from the video clip and sorts the still image using the audio landmark 169. In some embodiments, the data analysis system 130 extracts sound from the video clip and sorts the sound using the audio landmark 169. In some embodiments, the data analysis system 130 sorts the video clip using the audio landmark 169 and stores the video clip in database 134.

For video clips that include both an optical landmark 128 and an audio landmark 169, the data analysis system 130 uses optical landmark 128, audio landmark 169, or both landmarks 128, 169, to identify the target building system 112. Optionally, in some embodiments, the data analysis system 130 extracts a still image from the video clip and sorts the still image using the optical landmark 128, the audio landmark 169, or both landmarks 128, 169. In some embodiments, the data analysis system 130 extracts sound from the video clip and sorts the sound using the optical landmark 128, the audio landmark 169, or both landmarks 128, 169. In some embodiments, the data analysis system 130 sorts the video clip using the optical landmark 128, the audio landmark 169, or both landmarks 128, 169, and stores the video clip in database 134.

Although FIGS. 1-3 show a building monitoring system 100 in which the image capture devices 110 and audio capture devices 114 are separate physical devices, in some implementations a unified audio and video capture device may be used to implement both functions using a single physical device. In some embodiments, image capture devices 110 also function as security cameras to provide full motion video to a building security system.

In some implementations, the image capture devices 110 are installed to take advantage of existing power and data sources. For example, image capture devices 110 may be provided with installation kits including a collection of pre-configured Wi-Fi mesh nodes for quick Internet provisioning. Cameras, microphones, and sensors are also pre-commissioned with connection to the Wi-Fi mesh, or to sensor hubs that are pre-commissioned with connection to the Wi-Fi mesh. By preconfiguring the devices, the collection of devices is immediately functional upon deployment of a building monitoring system 100 or when added to an existing building monitoring system 100.

In some implementations, installation kits include mounting hardware designed to utilize commonly encountered attachment surfaces such as round dial gauges, flat metal instrument panels, ceiling tile grids, plants, lighting fixtures, electrical outlets, windows, etc., so that image capture devices 110, audio capture devices 114, and other sensors may be expediently deployed.

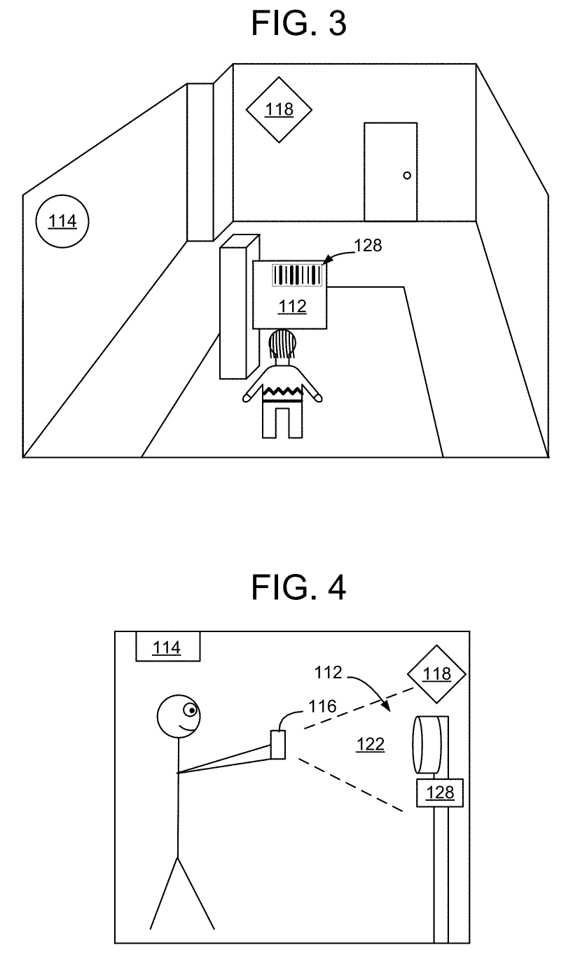

FIGS. 3-4 are functional block diagrams illustrating an example of data collection in a building monitoring system 100 in accordance with some embodiments of the present disclosure. As shown in FIGS. 3-4, in some embodiments a mobile audio and video capture device 116 is included as part of the building monitoring system 100 and used to capture images of the target building system 112 and audio sound clips of sound in the environment including the target building system 112. For example, as shown in FIG. 3, a person carrying a smartphone configured to be used as a mobile audio and video capture device 116 may enter a room and approach the target building system 112 to be monitored. As shown in FIG. 4, the person may use the mobile audio and video capture device 116 to take a picture of the target building system 112 and optical landmark 128, and optionally may also record a sound clip of sound in the room. The sound includes ambient sound in the room, including sound produced by the target building system 112, as well as an audio landmark 169 created by the audio beacon 118.

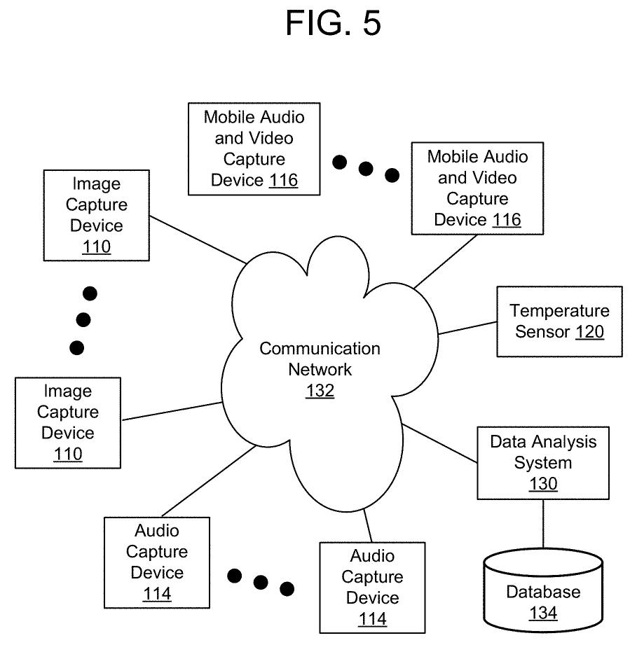

For example, patrolling personnel such as security guards and facilities management staff may supplement the gathering of building data using building management system application 182 running on a mobile phone 180 or other electronic device. The building management system application 182, in some embodiments, has a user interface configured to enable acquisition of images or sound clips of target building systems 112 and is configured to upload the images and sound clips to the data analysis system 130 (see FIG. 5).

FIG. 5 is a functional block diagram of an example building monitoring system 100. As shown in FIG. 5, in some implementations image capture devices 110, audio capture devices 114, temperature sensors 120, and mobile audio and video capture devices 116, are interconnected by communication network 132. Communication network 132 may be a wired network such as an Ethernet network or a wireless network such as a Wi-Fi network, a ZigBee network, or another type of wireless network implemented using another wireless communication protocol. In some embodiments, communication network 132 is a self-configuring wireless mesh network.

Data collected by components of the building monitoring system 100 is passed over communication network 132 to a data analysis system 130. Data analysis system 130 maintains a database 134 of previously collected images, sound clips, and information derived from previous images and sound clips, and uses the information in the database 134 to analyze newly captured images from the image capture devices 110 and/or from the mobile audio and video capture devices 116. Likewise, data analysis system 130 uses information about previously recorded sound clips in the database 134 to analyze newly captured sound clips from the audio capture devices 114 and/or from the mobile audio and video capture devices 116.

As noted above, in some implementations optical landmarks 128 are associated with target building systems 112. Managing the numerous images from numerous devices is an important task. One way to alleviate the need to track cameras is to include an optical landmark 128 in the image. For example, in some embodiments a machine-readable code is affixed to the target building system 112 or provided proximate to each target building system 112, so that every image of the target building system 112 includes information encoded by the optical landmark 128. Information encoded by the optical landmark is used by the data analysis system 130 to identify the target building system 112 and look up associated information such as target building system 112 location, measurement property, etc. Commissioning and image file management is thus simplified because it is not necessary to track the specific image capture device 110 from which each image originates. Bringing an image capture device 110 online is simplified, and malfunctioning image capture devices 110 may be easily swapped. All images, including manually collected images from the mobile audio and video capture devices 116 may simply be uploaded to a single directory of unorganized images in the data analysis system 130. Computer vision is then used to sort the incoming images into subdirectories as desired within database 134 as desired according to customer, building, room, target building system 112, etc.

In some embodiments, building management system application 182 is configured to implement a commissioning process that is used when initially affixing an optical landmark 128 to a target building system 112, to enable information such as the customer, location, and equipment type, to be associated with the optical landmark 128. Other information that may be collected may include the type of gauge, the value difference between divisions on the gauge, an expected normal range, information about gauge readings that may be considered abnormal, and other information that may be of use by the data analysis system 130 when processing subsequent images. In some embodiments, building management system application 182 user interface is configured to ask the user to take a picture of the optical landmark 128, verify that the image is satisfactory, and then ask the user to enter corresponding information regarding the target. The picture of the optical landmark 128 and corresponding information is then uploaded to the data analysis system 130. Optionally a test analysis of the image may be performed by the data analysis system 130 during the commissioning phase so that the installer may provide feedback to the data analysis system 130 confirming that the data analysis system 130 is correctly interpreting the image or correcting the data analysis system 130 interpretation of the image. In some embodiments, the optical landmark 128 is also used to aid in camera focusing and exposure settings.

In some implementations, computer vision is used by data analysis system 130 to analyze the collected images. For example, both analog and digital displays may be read and the numerical values logged. Plots of values (including directly obtained from sensors) over time provide a history and enable projections of future values, such as anticipated temperatures, pressures, tank levels, and other measurable values. Cyclical behavior is also able to be characterized. Unusual behavior, outside of expected behavior values, may indicate leaks or other malfunctions. In some implementations, image analysis is also used to evaluate stockroom inventory levels, estimate room occupancy, or estimated room cleanliness. Sound clip analysis, in some implementations, is used to detect the presence of alarm sounds and log or evaluate machine operation.

In some embodiments, the frequency of image capture, sound capture, and other sensor readings is determined based on ongoing analysis. For example, in some embodiments the data analysis system 130 is configured to instruct the image capture device 110 to take a photograph of the target building system 112 if a sound clip from the audio capture device 114 detects an unusual sound. Likewise, in some embodiments, the data analysis system 130 is configured to instruct the image capture device 110 to take photographs of the target building system 112 more frequently where the most recent data indicates significant changes between images, sound clips, or sensor readings. Conversely, the image capture rate or sound clip capture rate may be reduced where very little change is noticed between consecutive data points. Drastic changes in consecutive images, in some embodiments, indicate that an image capture device 110 has been moved out of alignment.

In some embodiments, when a change is noted by the data analysis system 130, an alert message is generated which is transmitted as an email, text message, phone call, or by posting information about the change to a news feed containing notifications about target building systems 112 for the customer. In addition to notifications based on detected changes to the target building systems 112, notifications may also be generated based on a lack of data. For example, in some embodiments the customer is notified if a fixed image capture device 110 has not taken a scheduled image of a particular target building system 112. Likewise, in some embodiments, the customer is notified that it is time to take a manual image of a target building system 112 using mobile audio and video capture device 116.

FIG. 6 is a functional block diagram showing several of the components of the building monitoring system 100 in greater detail. As shown in FIG. 6, in some implementations an image capture device 110 includes a camera 150, an image processing system 152, a control system 154, and a communication module 156. The camera 150 is used to capture images 158, and operates under the control of control system 154. In some embodiments, control system 154 controls the timing of image acquisition and adjusts focus of the camera 150 based on feedback from the data analysis system 130. Communication module 156 transmits images 158 on communication network 132 and receives control instructions via communication network 132. In some embodiments, image 158 includes information encoded by optical landmark 128.

Optionally, image processing system 152 pre-processes images 158 from camera 150 to extract information from the images 158 in a manner similar to data analysis system 130.

Audio capture device 114, in some implementations, includes a transducer 160, an audio processing system 162, a control system 164, and a communication module 166. The transducer 160 is used to capture sound 168 from the target building system 112 and operates under the control of control system 164. Control system 164 controls the timing of sound clip acquisition and adjusts sensitivity of the transducer 160 based on feedback from the data analysis system 130. Communication module 166 transmits sound clips encoding sound 168 on communication network 132 and receives control instructions via communication network 132. In some embodiments, sound clips obtained by audio capture device 114 include sound from audio beacon 118 encoding an audio landmark 169.

Optionally, audio processing system 162 pre-processes sound clips encoding sound 168 from transducer 160 to extract information from the sound clips in a manner similar to data analysis system 130.

Data analysis system 130, in some implementations, includes a control system 170, a communication module 172, an image processing system 174, an audio processing system 176, and a database interface 178. In some implementations, control system 170 is responsible for overall operation of the building monitoring system 100. Images 158 from image capture devices 110 and from mobile audio and video capture devices 116 are received by communication module 172 of data analysis system 130 via network 132, and passed to image processing system 174 for analysis. In some implementations, the image processing system 174 uses computer vision to analyze the images 158. In some implementations, the image processing system 174 detects the presence of optical landmarks 128 within images 158 to retrieve other previous images having the same optical landmark 128 via database interface 178 from database 134. In some implementations, image processing system 174 analyzes the images 158 in the context of previous images 158 of the target building system 112 to look for changes to the target building system 112.

Sound clips from audio capture devices 114 are received by communication module 172 via network 132 and forwarded to audio processing system 176 for analysis. In some implementations audio processing system 176 performs volume and frequency analysis of the sound clip to determine a volume of the sampled sound and a frequency spectrum of the sound 168 represented by the sound clip. In some implementations, the audio processing system 176 detects the presence of an audio landmark 169 generated by an audio beacon 118 within the sound clip and uses the audio landmark 169 of the audio beacon 118 to instruct the database interface 178 to retrieve other previous sound clips of the same target building system 112 from database 134. Audio landmark 169 is also used, in some embodiments, as a calibration reference to determine the volume of the sound in the sound clip. In some implementations, audio processing system 176 analyzes the sound 168 in the context of previous sound clips of the same target building system 112.

In some implementations, the building monitoring system 100 includes a building monitoring system application 182 designed to run on a mobile device 180 such as a smartphone, tablet computer, or laptop computer. As noted above, optionally building monitoring system application 182 enables mobile device 180 to function as a mobile audio and video capture device 116 within building monitoring system 100. Building monitoring system application 182 is also used in the commissioning process when setting up a target building system 112 to be monitored. Likewise, building monitoring system application 182 allows for the display of target building system 112 status notifications and alerts.

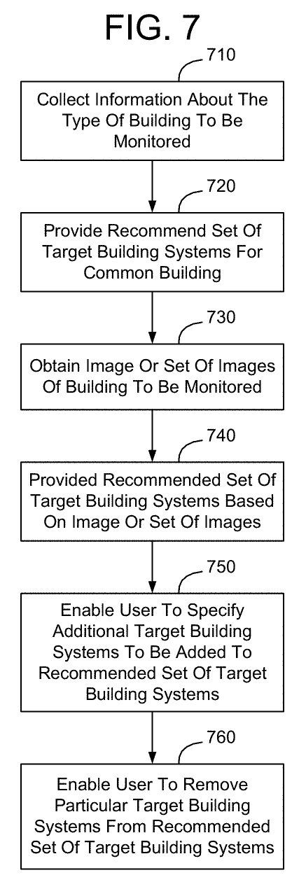

FIGS. 7-13 are flow charts of example methods implemented in accordance with some embodiments of the present disclosure. FIG. 7 shows an example method of target selection in which an initial set of target building systems 112 is defined. The target building systems 112 identified in the target selection process are used during initial configuration of the building monitoring system 100. In some implementations, in block 710, the method includes collecting information about the type of building to be monitored, e.g. by asking a user of the building monitoring system application 182 a series of questions. Example questions may include, for example, the type of building to be monitored, the size of the building, the age of the building, and other aspects that may help characterize the building and the intended use of the building. For example, a common set of target building systems 112 may exist for office buildings, whereas different common sets of target building systems 112 may exist for retail office space, manufacturing buildings, restaurants, mixed use buildings, or other types of buildings. Based on the information collected in block 710, a recommended set of target building systems 112 for the type of building is provided in block 720.

In addition to collecting information about the type of building to be monitored in block 710, in some implementations the method also includes obtaining an image or a set of images of the building to be monitored in block 730. The images may be of the exterior of the building, the interior of the building, particular rooms within the building, or other images. Based on the images, in block 740, the method includes providing a recommended set of target building systems 112 for the particular building based on the image or set of images. The use of images to provide a recommended set of target building systems 112 may be used instead of or in addition to the information received in block 710.

Once a recommended set of target building system 112 has been created, the building monitoring system application 182 enables the user to specify additional target building systems 112 to be monitored in block 750. Likewise, the building monitoring system application 182 enables the user to remove particular target building systems 112 in block 760

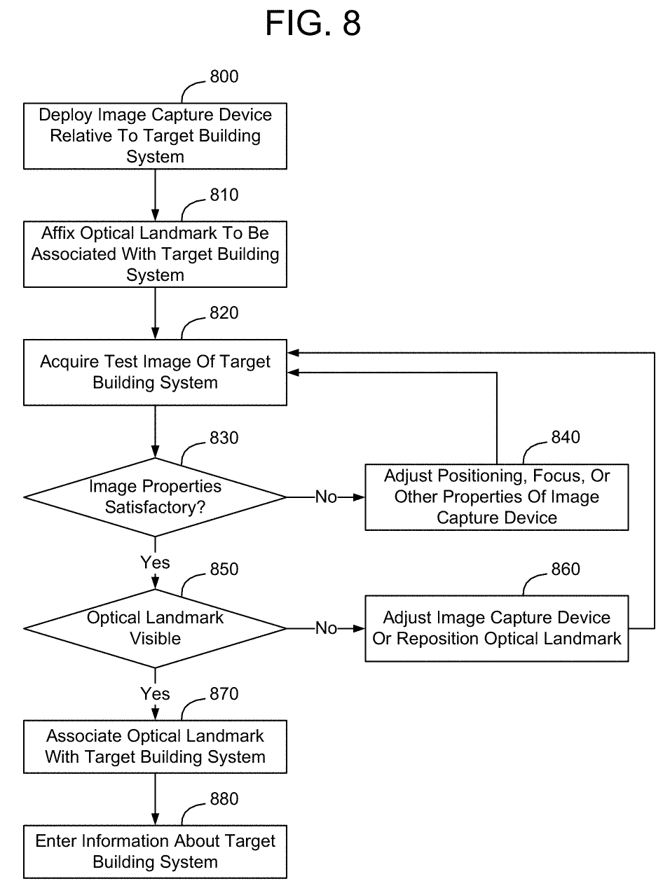

For each target building system 112 that is to be monitored, some initial configuration information is provided to the building monitoring system so that it has context for data that is collected in connection with monitoring the various target building systems 112. FIG. 8 is a flow chart of an example initial configuration process that may be implemented to obtain configuration data for a target building system 112.

As shown in FIG. 8, in some embodiments if a fixed image capture device 110 is to be used to monitor a target building system 112, the method includes deploying an image capture device 110 relative to the target building system 112 in block 800. In some embodiments deploying an image capture device 110 includes physically positioning the image capture device 110 relative to the target building system 112 and aligning the camera 150 of the image capture device 110 so that the target building system 112 is within the field of view 122 of the camera 150.

In some embodiments, the image capture device 110 may be physically attached to a mount for example using a universal mounting kit. The universal mounting kit may include specific hardware that is adapted to be able to be attached to common types of gauges or building features. For example, in some embodiments, the universal mounting kit includes a mount that enables the image capture device 110 to attach to a cross-bar of a drop ceiling, a mount that enables the image capture device 110 to attach to a round dial gauge, and other types of mounts that facilitate rapid deployment of the image capture device 110. In some implementations, the universal mounting kit enables the image capture device 110 to be installed in an existing lighting fixture, for example using a luminaire clip-on or power line clip-on, which may have the additional benefit of enabling the image capture device 110 to be powered from the lighting fixture power source.

In some embodiments, deploying an image capture device 110 includes connecting the image capture device 110 to communication network 132. In some embodiments, the image capture device 110 is preconfigured to participate in a WIFI mesh network such that the set of image capture devices 110, audio capture devices 114, temperature sensors 120, and other data capture devices form a self-configuring wireless mesh network as they are deployed within the building, and use this self-configuring wireless mesh network as communication network 132. In other embodiments, the image capture devices 110 is preconfigured to join an existing wireless (e.g. WIFI) network and use the existing wireless network as communication network 132.

As noted above, in some instances a target building system 112 is monitored by a deployed image capture device 110 and in other instances the target building system 121 is monitored by a mobile audio and video capture device 116. If the target building system 112 is not to be monitored by a fixed image capture device 110, the method step shown in block 800 may be skipped.

In some embodiments, in block 810, an optical landmark 128 is affixed to be associated with the target building system 112. In instances in which the target building system 112 is to be monitored by an image capture device 110, the optical landmark 128 should be affixed relative to the target building system 112 such that the field of view 122 of the image capture device 110 includes both the optical landmark 128 and the target building system 112. In instances in which the target building system 112 is to be monitored by a mobile audio and video capture device 116, the optical landmark 128 should be affixed relative to the target building system 112 such that the field of view 122 of the mobile audio and video capture device 116 includes both the optical landmark 128 and the target building system 112.

Once the optical landmark 128 has been affixed in block 810, a test picture of the target building system 112 is acquired in block 820. The test image is analyzed, either locally by building monitoring system application 182 or remotely by data analysis system 130, to determine if the test image properties are satisfactory in block 830. In some embodiments, determining if the properties of the test image are satisfactory includes using features of the optical landmark 128 detected within the test image to provide feedback on camera positioning. If the test image properties are not satisfactory (e.g., a determination of “no” at block 830), in some implementations the method includes providing input to the user via building monitoring system application 182 user interface as to how to adjust the positioning, focus, or other properties of the image capture device 110, in block 840. In embodiments in which the test image is taken with a mobile audio and video capture device 116, the method may provide feedback as to how to reposition the mobile audio and video capture device 116 to better capture an image of the target building system 112 and optical landmark 128. The steps of acquiring a test image in block 820, determining in block 830, and adjusting in block 840, may iterate until the test image is determined to be satisfactory (e.g., a determination of “yes” in block 830).

In addition to determining if the image of the target building system 112 is satisfactory, a determination is made as to whether the optical landmark 128 is visible in block 850. If the optical landmark 128 is not visible or is difficult to decipher, the image capture device 110 may be adjusted or the optical landmark 128 may be repositioned, as shown in block 860. The process of acquiring a test picture of the target building system 112 in block 820, analyzing the test picture in blocks 830 and 850, and adjusting in blocks 840 and 860 may iterate until a satisfactory test image has been acquired.

In addition to acquiring an image of the target building system 112, the method also associates the optical landmark 128 with the target building system 112 in block 870. Although block 870 appears within FIG. 8 below block 850, the step of associating the optical landmark 128 with the target building system 112 may occur in connection with affixing the optical landmark 128 with the target building system 112 (block 810) or at another point in the method.

In some embodiments, optical landmarks 128 are pre-printed sheets of unique codes. In some embodiments, optical landmarks 128 are dynamically created for example using a barcode or QR code generator, or downloaded from a website, and printed, for example with a portable printer. In some embodiments, the optical landmarks 128 are unique within the building monitoring system 100 such that no two optical landmarks 128 are the same. Including an optical landmark 128 in images facilitates image file ID and sorting by the data analysis system 130, and enables the data analysis system 130 to determine a source of an image without requiring additional collection and analysis of image metadata. For example, in embodiments in which multiple mobile audio and video capture devices 116 are being used to obtain images of target building systems 112, the use of optical landmarks 128 within the images themselves eliminates the need for the data analysis system 130 to obtain further information from the mobile audio and video capture devices 116 to determine which images are associated with which target building systems 112. Hence, all images are able to be uploaded to the data analysis system 130 without requiring further input or information about the source of the images.

In some embodiments, in addition to associating an optical landmark 128 with the target building system 112, additional information is collected about the target building system 112 by enabling information about the target building system 112 to be entered in block 880. Example information that is entered includes information about the target building system 112 such as the location of the target building system 112, the type of target building system 112, and the type of measurement that is to be performed. For example, in embodiments in which the target building system 112 includes a dial 124 and the building monitoring system 100 is intended to monitor the value of the dial 124, information about the dial 124 such as the values of tick marks on the dial 124, and a normal operating range is entered. Upon entry of the information in block 880, the test image may optionally be processed to verify that the data analysis system 130 may identify relevant aspects of the target building system 112 to be monitored, such as for example to determine that the data analysis system 130 may identify the tick marks and may read the value of the dial 124. By providing information about the target building system 112, the human input may be used to help tune the machine learning algorithms used by the data analysis system 130 to help the data analysis system 130 more accurately read information from future images of the target building system 112.

In addition to facilitating sorting of images of target building systems 112, in some embodiments the optical landmarks 128 also are used by the data analysis system 130 to provide guidance with respect to scale, rotation, parallax, and type of target building system 112 that is being monitored. In some embodiments, the optical landmarks 128 have calibrated feature sizes which enables the optical landmark 128 to serve as a reference or to be used to estimate angles of observation when the camera is not exactly perpendicular to the optical landmark 128 and/or not exactly perpendicular to the target building system 112.

In some embodiments, in addition to the use of optical landmarks 128, other additional image processing aids are placed on or around the target building system 112. For example, a marking kit with special labels, pens, etc., is used to create computer vision aids to help provide distinguishing features to the target building system 112 that are used by the data analysis system 130 to facilitate sorting of the images and facilitate interpretation of the images. For example, in some embodiments, markings help identify the target building system 112, identify features of interest such as by identifying which portion of the image includes the gauge, identify scale boundaries, and identify which image plane is to be captured.

If an optical landmark 128 is damaged or becomes difficult to read over time, in some embodiments a new optical landmark 128 is affixed to the target image system 112 to replace the previous optical landmark 128. In some embodiments replacing an optical landmark 128 includes scanning the previous optical landmark 128, scanning the new optical landmark 128, and optionally acquiring a test image of the target building system 112 and processing the test image to determine whether the new optical landmark 128 is correctly placed relative to the target building system 112.

In some embodiments, if an optical landmark 128 is to be replaced, the optical landmark 128 is scanned and a new optical landmark 128 is created that is identical to the old optical landmark 128. In this manner, a damaged or dirty optical landmark 128 may be replaced with an identical optical landmark 128 to avoid updating the data analysis system 130 with information about the new optical landmark 128/target building system 112 association.

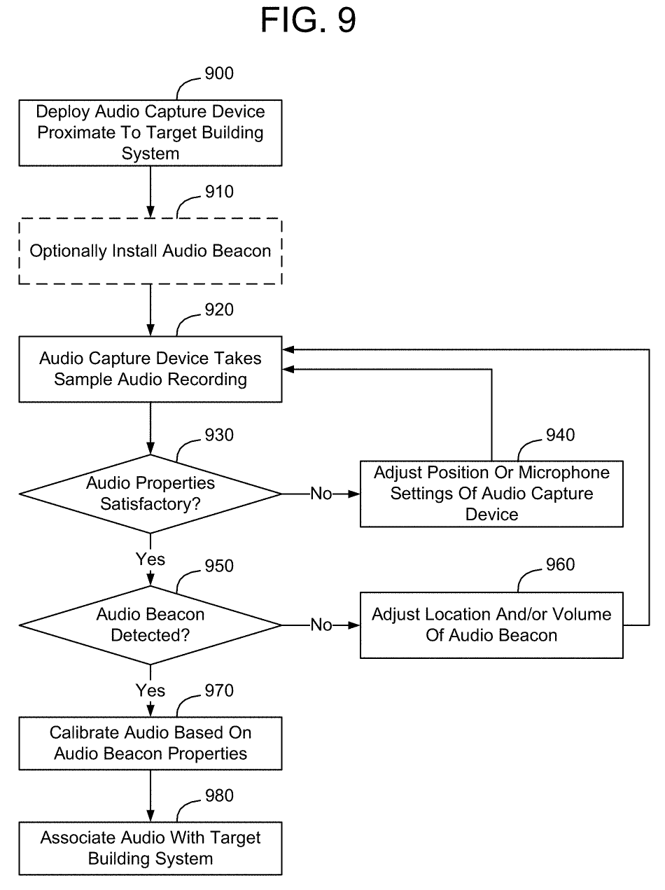

FIG. 9 is a flow chart showing an example method of capturing an initial sound clip of a target building system 112. Managing a large number of audio targets and discerning which target building system 112 is associated with a particular sound clip is implemented, in some embodiments, through the use of audio beacons 118. Specifically, by using an audio landmark 169, e.g. generated by an audio beacon 118, facilitates audio file identification and sorting. The audio beacon 118, in some embodiments, emits a calibrated and unique sound pattern that forms an audio landmark 169 that is discernible within audio collected by audio capture device 114. In some embodiments, sound produced by the audio beacon 118 is outside the human audible range (above about 20 kHz) but detectable by the transducer 160 of the audio capture device 114 or by the microphone of the mobile audio and video capture device 116.

In addition to helping identify the target building system 112, the sound output by the audio beacon 118 also serves as an intensity and position reference. In some embodiments, the signal includes information regarding the signal itself, such as intensities or frequencies, to identify both the identity of the audio beacon 118 and the type of sound (intensity and frequency) being output by the audio beacon 118.

As shown in FIG. 9, in some embodiments the method includes deploying an audio capture device 114 proximate to the target building system 112 to be monitored in block 900. In embodiments in which a mobile audio and video capture device 116 is to be used to monitor sound produced by the target building system 112 deploying an audio capture device 114 is not required.

In some embodiments, the method further includes deploying one or more audio beacons 118, in block 910, proximate the target building system 112. In embodiments in which a mobile audio and video capture device 116 is used to capture sound clips from the target building system 112, the use of deployed audio beacons 118 may not be required. For example, in some embodiments the mobile audio and video capture device 116 is used to capture an image of an optical landmark 128 associated with the target building system 112. Based on the identity of the optical landmark 128, the mobile audio and video capture device 116 outputs sound in the form of an audio landmark 169 to temporarily serve as an audio beacon 118. While outputting sound to function as a temporary audio beacon 118, the mobile audio and video capture device 116 then captures audio from the target building system 112 to generate a sound clip that includes both sound produced by the target building system 112 and the sound produced by the mobile audio and video capture device 116 itself. In this manner, it is possible to insert an audio landmark 169 into a sound clip without installing fixed audio beacons 118.

To associate an initial sound clip with a target building system 112, in block 920 the audio capture device 114 takes a sample audio recording to obtain a test sound clip. The test sound clip is then analyzed to determine if the audio properties are satisfactory in block 930. If the audio properties are not satisfactory (e.g., a determination of “no” in block 930), one or more aspects of the audio capture device 114 are adjusted in block 940, such as by adjusting the position of the audio capture device 114, adjusting the position of the microphone, or adjusting the gain or other settings of the audio capture device 114. The process of obtaining a sound clip in block 920, analyzing the sound clip in block 930, and adjusting in block 940 iterates until an acceptable sound clip is acquired.

The test sound clip is also analyzed in block 950 to determine if sound from audio beacon 118 is detectable in the sound clip. If sound from an audio beacon 118 is not detected in the sound clip in block 950, the location and/or volume of the audio beacon 118 is adjusted in block 960. The process of obtaining a sound clip in block 920, analyzing the sound clip in block 950, and adjusting in block 960 iterates until an acceptable sound clip is acquired.

In block 970, the audio from the audio capture device 114 is calibrated based on the audio beacon 118 properties. This aids in future sound processing. In some embodiments, the audio beacon 118 provides a reference level against which to compare sound intensity or frequency of audio signal from the monitored target building system 112. For stereo microphones, the audio beacon 118 serves as a spatial landmark to indicate which detected sounds belong to a desired monitored target building system 112. In some embodiments, the audio beacon 118 emits a sound at a high frequency above the human audible frequency range. This high frequency combines with sound emitted from the target building system 112 to create a lower frequency beat frequency, within a sensitivity range of the transducer 160. In this manner, the effective sensitivity range of the transducer 160 may be effectively increased to enable a given audio capture device 114 to detect audio frequencies outside its normal effective sensitivity range.

In block 980 the test sound clip is associated with the target building system 112. Associating the test audio with the target building system 112, in some embodiments, includes entry of information about the target building system 112. In some embodiments, association of the test sound clip with the target building system 112 includes obtaining an image of an optical landmark 128 associated with the target building system 112 and using the image of the optical landmark 128 to identify the target building system 112. By correlating the audio and video, it is possible to reuse data already known to the building monitoring system 100 during the commissioning process.

Additional information, such as expected audio intensity levels, possible alarm tones, and other information may optionally additionally be manually input. During operation, detection of sound from the audio beacon 118 at its expected intensity is interpreted to infer that the audio capture device 114 is positioned correctly and functioning, particularly in the absence of detectable sounds from the target building system 112.

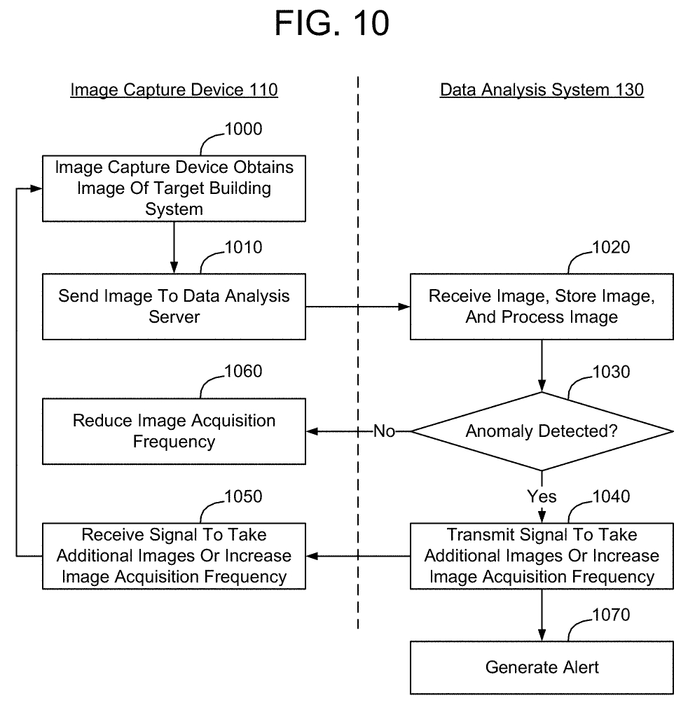

FIG. 10 is a flow chart showing an example process of image acquisition sampling control. As shown in FIG. 10, in some embodiments an image capture device 110 obtains an image of a target building system 112 in block 1000. The image capture device 110 then transmits the image to the data analysis system 130 in block 1010. The data analysis system 130 receives the image, stores the image, and processes the image in block 1020. If an anomaly is detected (e.g., a determination of “yes” at block 1030), the data analysis system 130 transmits a signal to the image capture device 110 to instruct the image capture device 110 in block 1040 to take additional images of the target building system 112 or to increase the image acquisition frequency. When the image capture device 110 receives the signal in block 1050, the image capture device 110 responds by taking additional images of the target building system 112 or increasing the frequency with which images of the target building system 112 are obtained according to the received signal. If no anomaly is detected (e.g., a determination of “no” at block 1030), optionally the image capture device 110 is instructed in block 1060 to reduce the image acquisition frequency of the target building system 112. Hence, in some embodiments the image acquisition frequency changes dynamically based on previous data collected. Optionally the image acquisition frequency may also depend on connection bandwidth on communication network 132, device hardware speeds, and other physical considerations. Optionally, if an anomaly is detected (e.g., a determination of “yes” at block 1030), an alert may be generated in block 1070.

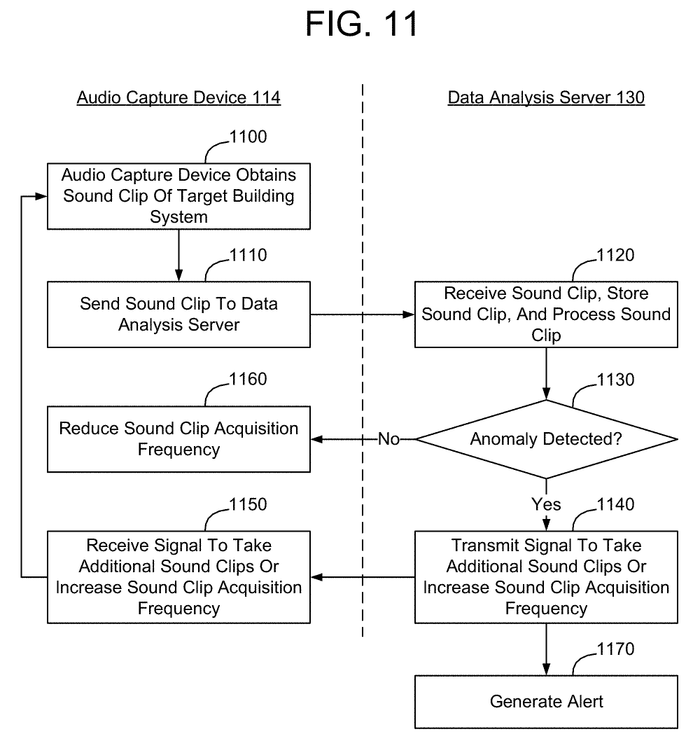

FIG. 11 is a flow chart showing an example process of audio acquisition sampling control. As shown in FIG. 11, in some embodiments an audio capture device 114 obtains a sound clip of a target building system 112 in block 1100. The audio capture device 114 then transmits the sound clip to the data analysis system 130 in block 1110. The data analysis system 130 receives the sound clip, stores the sound clip, and processes the sound clip in block 1120. If an anomaly is detected (e.g., a determination of “yes” at block 1130), the data analysis system 130 transmits a signal to the audio capture device 114 to instruct the audio capture device 114 in block 1140 to take additional sound clips of the target building system 112 or to increase the sound clip acquisition frequency. When the audio capture device 114 receives the signal in block 1150, the audio capture device 114 responds by taking additional sound clips of the target building system 112 or increasing the frequency with which sound clips of the target building system 112 are obtained. If no anomaly is detected (e.g., a determination of “no” at block 1130), optionally the audio capture device 114 is instructed in block 1160 to reduce the sound clip acquisition frequency of the target building system 112. Hence, in some embodiments the sound clip acquisition frequency changes dynamically based on previous data collected. Optionally the sound clip acquisition frequency may also depend on connection bandwidth on communication network 132, device hardware speeds, and other physical considerations. Optionally, if an anomaly is detected (e.g., a determination of “yes” at block 1130), an alert may be generated in block 1170.

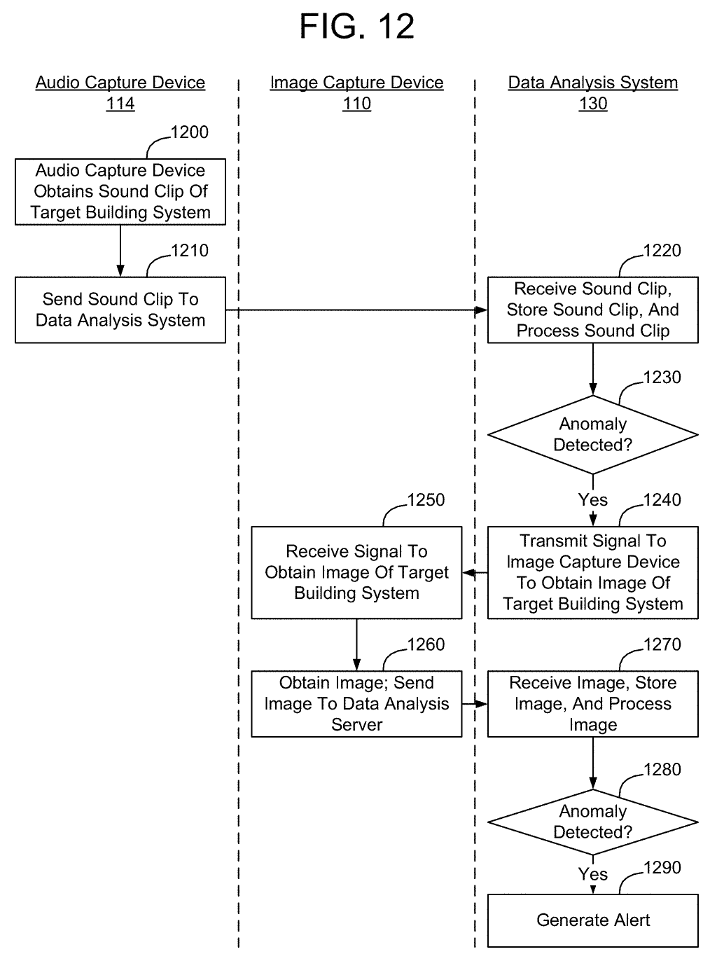

FIG. 12 is a flow chart showing an example process in which data acquired by an audio capture device 114 is used to adjust operation of the image capture device 110. As shown in FIG. 12, in some embodiments an audio capture device 114 obtains a sound clip of a target building system 112 in block 1200. The audio capture device 114 then transmits the sound clip to the data analysis system 130 in block 1210.

The data analysis system 130 receives the sound clip, stores the sound clip, and processes the sound clip in block 1220. If an anomaly is detected (e.g., a determination of “yes” at block 1230), the data analysis system 130 transmits a signal to the image capture device 110 associated with the target building system 112, to instruct the image capture device 110 in block 1240, to obtain an image of the target building system 112.

When the image capture device 110 receives the signal to obtain an image of the target building system 112 in block 1250, the image capture device 110 obtains the requested image and sends the image to the data analysis system 130 in block 1260.

The data analysis system 130 receives the image, stores the image, and processes the image in block 1270. If an anomaly is detected (e.g., a determination of “yes” at block 1280), an alert message is generated in block 1290 or other corrective action is taken.

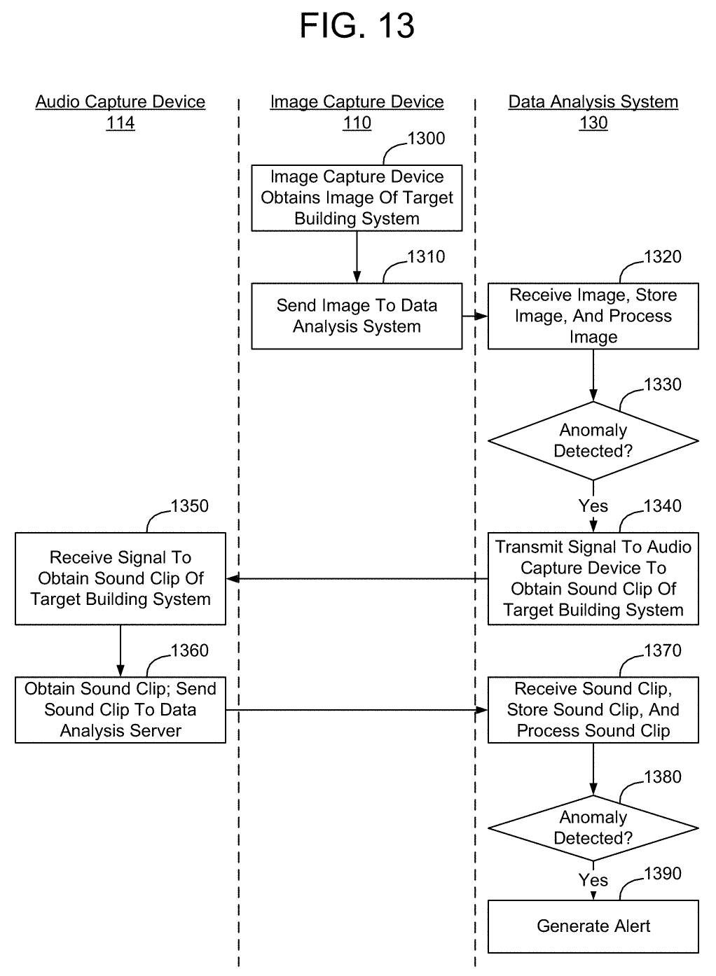

FIG. 13 is a flow chart showing an example process in which data acquired by an image capture device 110 is used to adjust operation of the audio capture device 114. As shown in FIG. 13, in some embodiments an image capture device 110 obtains an image of a target building system 112 in block 1300. The image capture device 110 then transmits the image to the data analysis system 130 in block 1310.

The data analysis system 130 receives the image, stores the image, and processes the image in block 1320. If an anomaly is detected (e.g., a determination of “yes” at block 1330), the data analysis system 130 transmits a signal to the audio capture device 114 associated with the target building system 112, to instruct the audio capture device 114, in block 1340, to obtain a sound clip of the target building system 112.

When the audio capture device 114 receives the signal to obtain a sound clip of the target building system 112 in block 1350, the audio capture device 114 obtains the requested sound clip and sends the sound clip to the data analysis system 130 in block 1360.

The data analysis system 130 receives the sound clip, stores the sound clip, and processes the sound clip in block 1370. If an anomaly is detected (e.g., a determination of “yes” at block 1380), an alert message is generated in block 1390 or other corrective action is taken.

Accordingly, in some embodiments data acquired by one type of sensor is used to trigger other types of sensors to acquire data. For example, if analysis of data from sensor #1 indicates that additional data is needed, triggers may be sent to other sensors known to be in the vicinity of sensor #1 or a command may be sent to sensor #1 to broadcast a signal that causes nearby sensors to acquire data. Sensor #1 may also decide to trigger data acquisition at neighboring devices based on comparison of its data with a local threshold without requiring analysis of the data by the data analysis system 130. Likewise, by collecting audio and visual inputs from different sources to create triggers, it is possible to infer events from a collection of data from different sensors. Optionally, when an event occurs, a user of the building monitoring system 100 may characterize the event to help the building monitoring system 100 discern similar future events.

In some embodiments, special conditions trigger sampling by image capture device 110, audio capture device 114, or by a user of mobile audio and video capture device 116. Example special conditions may include weather, earthquakes, security alarms, accidents, and other unusual occurrences. For example, an external data feed may trigger a data acquisition command to be sent to a device, or local sensors at a device may detect conditions which trigger data acquisition. As another example, an image capture device 110 may have a microphone that is designed to listen for sound produced by the audio beacon 118. The image capture device 110 may be configured to obtain a picture of the target building system 112 when the audio beacon 118 outputs a particular sound. Likewise, the image capture device 110 may be combined with an audio capture device 114 to enable the image capture device 110 to take pictures of the target building system 112 when the sound produced by the target building system 112 is unusual.

In some embodiments, for example in embodiments in which there is limited bandwidth on communication network 132, an increase in acquisition frequency by audio capture device 114 may require a concomitant reduction in acquisition frequency by image capture device 110. Likewise, an increase in acquisition frequency by image capture device 110 may require a concomitant reduction in acquisition frequency by audio capture device 114.

In some embodiments, if the data analysis system 130 determines the possible occurrence of an event, the data analysis system 130 generates an alert message in block 1390. In some embodiments, alert messages are transmitted on communication network 132 and appear as messages in the building monitoring system application 182. Optionally, the building management system application 182 user interface is configured to receive instructions from the user to enable the user to instruct the building monitoring system 100 to acquire additional images and/or sound clips of the target building system 112.

Lightning may have a deleterious effect on building systems, particularly electronic building systems. In some embodiments, light sensors and audio capture devices 114 are deployed to track lightning and thunder. The data analysis system 130 uses data collected from the light sensors and audio capture devices 114 to evaluate a distance of a lightning storm based on the time delay in thunder detection. When the data analysis system 130 determines that a thunderstorm is sufficiently close, power connections to the target building systems 112 are disconnected to isolate the target building systems 112 from a potential power surge.

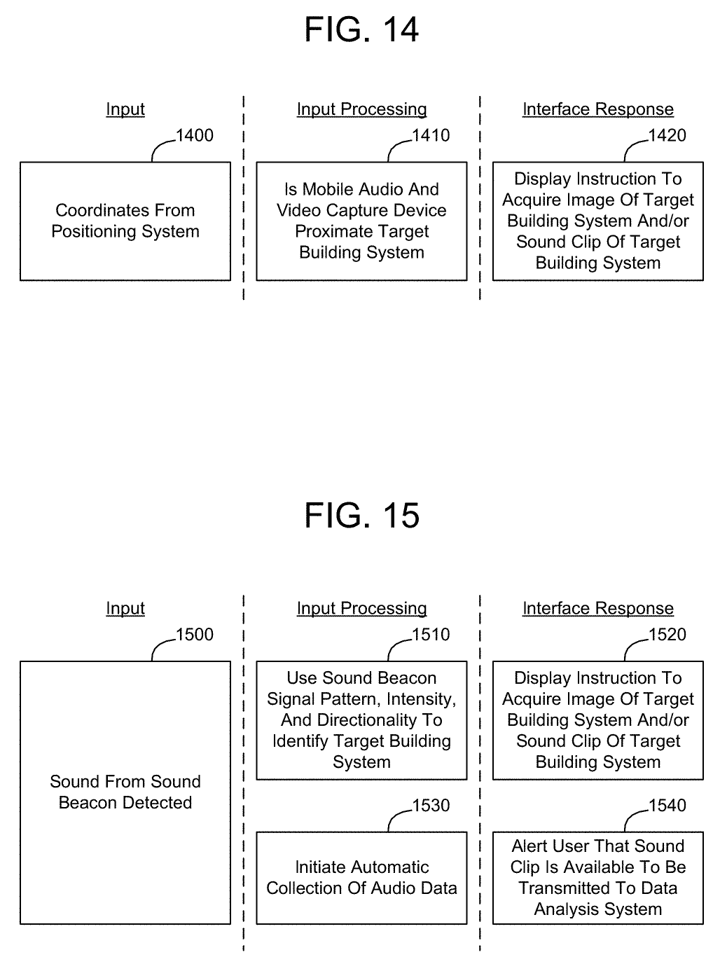

FIGS. 14-16 are block diagrams showing several user interface features of an example building monitoring system application 182 for interacting with an example building monitoring system 100, in accordance with some embodiments of the present disclosure. As noted above, in some embodiments the building monitoring system application 182 is run on a mobile device 180 configured to operate as a mobile audio and video capture device 116 in the building monitoring system 100. FIGS. 14-16 show the input to the building management system application 182, how the input is processed, and the user interface response.

As shown in FIG. 14, in some embodiments the building monitoring system application 182 is location aware, for example by receiving input in the form of coordinates from a positioning system 1400. Example positioning systems may include indoor positioning systems, GPS positioning systems, communication network 132 based positioning systems, and other positioning systems. The building monitoring system application 182 processes the coordinates, in block 1410, to determine whether the mobile device 180 is proximate a target building system 112. If the mobile device 180 is proximate a target building system 112, the user interface of the building monitoring system application 182 displays an instruction in block 1420 to instruct the user to acquire an image of the target building system 112 and/or to acquire a sound clip of the target building system 112.

In some embodiments, sounds output from the audio beacons 118 are used to help the user find target building systems 112 within a room. In some embodiments, for image targets, the mobile audio and video capture device 116 uses audio beacon 118 signal pattern, intensity, and directionality to identify the target building system 112, and then guides the user to the target. For audio targets, the user needs only to be in the same room or otherwise within audible range to be able to identify the target building system 112 and gather a sound clip using the mobile audio and video capture device 116. Audio data thus may easily be gathered even in dark rooms. The building monitoring system application 182 does not need to know its location through visual cues or via positioning system coordinates. In some embodiments, the building monitoring system application 182 calculates the room, changes the user interface to match the room, knows where the target building systems 112 are located within the room, and uses the user interface to show the user which target building systems 112 are to be imaged.

As shown in FIG. 15, in some embodiments, the input to the building monitoring system application 182 in block 1500 is sound from an audio beacon 118. The input is processed, in block 1510, for example by using the audio beacon 118 signal pattern, intensity, and directionality to identify the target building system(s) 112 within the room. The user interface response, in block 1520, is to display an instruction on the graphical user interface to instruct the user to acquire an image of the target building system 112.

In some embodiments, upon determination of the location of the mobile audio and video capture device 116, the building monitoring system application 182 user interface provides the user with guidance as to how to capture images of target building systems 112 within the vicinity. For example, in some embodiments the user interface shows the user what the target building system 112 looks like, its approximate location within the room, where the user should stand relative to the target building system 112, what aspect of the target building system 112 is important to capture within the image, and other aspects of how to take the image. In some embodiments, the user interface displays a previous photograph of the target building system 112 and/or a grayed-out image that the user should match when taking the current photograph. Thus, in some embodiments a location-aware collage of previous images of targets pops up on the user interface to guide the user as to how/where to capture an image, and provides the user with visual and/or audio cues to align the frame with the target building system 112.

In some embodiments, receipt of sound from audio beacon 118, in block 1500, initiates automatic collection of audio data in block 1530. Optionally the user interface may alert the user, in block 1540, that a sound clip is being collected or is available to be transmitted to the data analysis system 130. In some embodiments, the audio beacon 118 alerts mobile device 180 to start collecting data and even automatically causes the building monitoring system application 182 to open on the mobile device 180. In some embodiments, the audio beacon 118 also emits a human audible sound, such as a brief chirp, to help the user find the target building system 112.

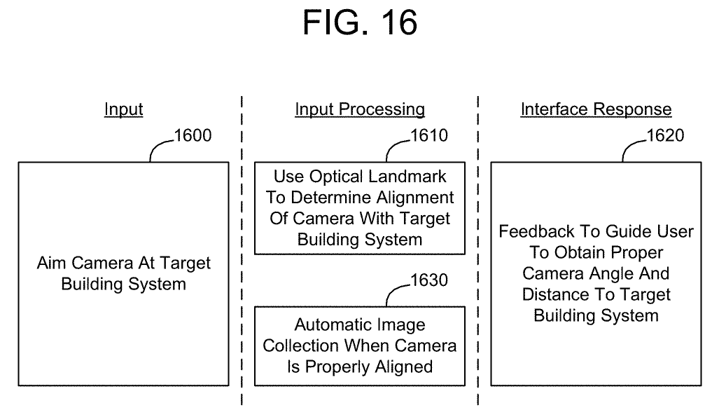

As shown in FIG. 16, in some embodiments the input to building monitoring system application 182, in block 1600, is video captured when a camera 150 of the mobile device 180 is aimed at a target building system 112. In some embodiments, the optical landmark 128 is used in block 1610 to determine alignment of the camera 150 with the target building system 112. In some embodiments alignment of the field of view 122 of the mobile audio and video capture device 116 is assisted by the optical landmark 128, and the building monitoring system application 182 processes the video input in real time to detect the optical landmark 128 within the field of view 122 and provide feedback to the user as to the positioning of the mobile audio and video capture device 116 relative to the target building system 112. Optionally, in block 1620, feedback may be provided via the user interface regarding the image quality and, if the image is insufficient, instructions may be provided to re-acquire a new image of the target building system 112.

In some embodiments, in block 1630, image capture occurs automatically once the mobile audio and video capture device 116 is correctly positioned relative to the target building system 112. For example, automatic image capture may occur where the field of view 122 correctly incorporates the target building system 112 and the optical landmark 128, without requiring the user to presses a button, tap the screen, or take any other affirmative action.

In some embodiments, the building monitoring system application 182 maintains a schedule of target building systems 112 to be monitored and provides reminders via the user interface of the need to gather data from particular target building systems 112. In some embodiments, the reminders are notifications to check on particular target building systems 112. In some embodiments, when the mobile audio and video capture device 116 is not able to automatically upload the images and sound clips to data analysis system 130, for example if the mobile audio and video capture device 116 acquires one or more images and sound clips while not connected to communication network 132, the notifications also include instructions to upload the images and sound clips of the target building systems 112.

In some embodiments, the data analysis system 130 is a cloud based system configured to use computer vision to read optical landmarks 128 and process audio landmarks 169. To manage storage space, in some embodiments digital data is extracted from the images and sound clips, and a small subset of the raw images/wave files are saved for later audit.

Multiple functions may be performed by the data analysis system 130. For example, in embodiments in which the data analysis system 130 stores historical images, the data analysis system 130 allows the images to be browsed. In embodiments in which the data analysis system 130 extracts digital data from the images and sound clips, data plots are created based on the historical digital data. For example, if the target building system 112 includes a dial 124, historical readings of the dial 124 may be stored instead of the pictures of the dial 124. The historical readings are used to create data plots showing past values, and optionally predictive trends are projected based on past data. Likewise, if the gauge reading is above or below a threshold, optionally an alert message is transmitted. Based on historical trends, projections are also provided and alerts generated to provide information as to when the gauge is expected to cross a threshold. Sudden changes in gauge readings indicate a leak or malfunction.

As another example, if the target building system 112 is a view of a work area, the images from the image capture device 110 are used to assess inventory, estimate cleanliness, estimate occupancy of the space, and make other determinations based on the visible conditions of the space. Thus, in some embodiments the target building system is the open space within the building itself.

As yet another example, using sound clips from the audio capture device 114, the data analysis system 130 detects an equipment alarm, identify which alarm is occurring, detect the sound being produced by the active equipment, and identify which piece of equipment is active and is producing the detected sound. Thus, when the user is notified of the existence of the alarm, the user is provided with an identification of the target building system 112 that generated the alarm, along with a sound clip of the operation of the target building system 112 so that the user knows what the target building system 112 sounds like at the time.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more non-transitory tangible computer-readable storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Read Only Memory (ROM), cache, optical or magnetic disk, CD, DVD, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the Internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s), personal digital assistant(s) (PDA(s)), handheld device(s) such as cellular telephone(s) or smart cellphone(s), laptop(s), tablet or handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit (CPU), graphics processing unit (GPU), an arithmetic logic unit, an application-specific integrated circuit (IC), and/or a task engine, with such examples provided for illustration and not limitation.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Implementations of the systems and methods described above include computer components and computer-implemented processes that will be apparent to those skilled in the art. Furthermore, it should be understood by one of skill in the art that the computer-executable instructions may be executed on a variety of processors such as, for example, microprocessors, digital signal processors, gate arrays, etc. In addition, the instructions may be implemented in a high-level procedural and/or object-oriented programming language, and/or in assembly/machine language. For ease of exposition, not every element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

The following reference numerals are used in the drawings:
100 building monitoring system
110 image capture device
112 target building system
114 audio capture device
116 mobile audio and video capture device
118 audio beacon
120 temperature sensor
122 field of view
124 dial
126 display panel
128 optical landmark
130 data analysis system
132 communication network
134 database
150 camera
152 image processing system
154 control system
156 communication module
158 image
160 transducer
162 audio processing system
164 control system
166 communication module
168 sound
169 audio landmark
170 control system
172 communication module
174 image processing system
176 audio processing system
178 database interface
180 mobile device
182 building monitoring system application

Although the methods and systems have been described relative to specific embodiments thereof, they are not so limited. Many modifications and variations may become apparent in light of the above teachings. Many additional changes in the details, materials, and arrangement of parts, herein described and illustrated, may be made by those skilled in the art. A number of implementations have been described. Nevertheless, it will be understood that additional modifications may be made without departing from the scope of the inventive concepts described herein, and, accordingly, other implementations are within the scope of the following claims.

What is claimed is:

1. A building monitoring system, comprising:
a plurality of image capture devices deployed to obtain images of target building systems, the target building systems being associated with optical landmarks visible by the image capture devices;
a plurality of audio beacons configured to output audio landmarks;
a plurality of audio capture devices deployed to obtain sound clips of the target building systems, each sound clip of the target building systems including at least one of the audio landmarks from the plurality of audio beacons; and
a data analysis system configured to:
receive the images of the target building systems;
receive the sound clips of the target building systems; and
identify each of the target building systems using at least one of the optical landmarks and the audio landmarks.

2. The building monitoring system of claim 1, wherein the plurality of image capture devices are fixed relative to the target building systems.

3. The building monitoring system of claim 1, wherein the optical landmarks are bar codes or Quick Response (QR) codes.

4. The building monitoring system of claim 1, wherein the audio landmarks are audio signatures in a frequency range above approximately 20 kHz to be outside a human audible frequency range.

5. The building monitoring system of claim 1, further comprising a mobile audio and video capture device configured to obtain images of the target building systems and optical landmarks, and configured to obtain sound clips of the target building systems and the audio beacons.

6. The building monitoring system of claim 5, wherein the data analysis system is further configured to receive the images and sound clips from the mobile audio and video capture device and sort the images from the mobile audio and video capture device using the optical landmarks, and to sort the sound clips from the mobile audio and video capture device using the audio landmarks.

7. The building monitoring system of claim 1, further comprising a mobile device executing a building monitoring system application configured to specify a new target building system to be monitored by the building monitoring system.

8. The building monitoring system of claim 7, wherein the building monitoring system application is configured to specify the new target building system by:
acquiring a test image of the new target building system to be monitored;
determining whether image properties of the test image are satisfactory; and
determining whether one of the optical landmarks is visible in the test image.

9. The building monitoring system of claim 7, wherein the building monitoring system application is configured to specify the new target building system by:
receiving user input comprising characterizing information about the new target building system to be monitored.

10. The building monitoring system of claim 7, wherein the building monitoring system application is configured to specify the new target building system by:
acquiring a test sound clip of the new target building system to be monitored;
determining whether audio properties of the test sound clip are satisfactory; and
determining whether one of the audio landmarks is audible in the test sound clip.

11. The building monitoring system of claim 1, wherein the data analysis system is further configured to:
analyze the images for an anomaly in the operation of the target building systems; and
in response to detecting an anomaly in the operation of a first target building system, instruct a first image capture device in the plurality of image capture devices to obtain additional images of the first target building system.

12. The building monitoring system of claim 1, wherein the data analysis system is further configured to:
analyze the sound clips for an anomaly in the operation of the target building systems; and
in response to detecting an anomaly in the operation of a first target building system, instruct a first audio capture device in the plurality of audio capture devices to obtain additional sound clips of the first target building system.

13. The building monitoring system of claim 1, wherein the data analysis system is further configured to:
analyze the images for an anomaly in the operation of the target building systems; and
in response to detecting an anomaly in the operation of a first target building system, instruct a first audio capture device in the plurality of audio capture devices to obtain additional sound clips of the first target building system.

14. The building monitoring system of claim 1, wherein the data analysis system is further configured to:
analyze the sound clips for an anomaly in the operation of the target building systems; and
in response to detecting an anomaly in the operation of a first target building system, instruct a first image capture device in the plurality of image capture devices to obtain additional images of the first target building system.

15. The building monitoring system of claim 1, wherein the data analysis system is further configured to:
analyze the images for an anomaly in the operation of the target building systems; and
in response to detecting an anomaly in the operation of a first target building system, instruct a mobile audio and video capture device to obtain a sound clip of the first target building system or to obtain additional images of the first target building system.

16. The building monitoring system of claim 1, wherein the data analysis system is further configured to:
analyze the sound clips for an anomaly in the operation of the target building systems; and
in response to detecting an anomaly in the operation of a first target building system, instruct a mobile audio and video capture device to obtain a sound clip of the first target building system or to obtain additional images of the first target building system.

17. The building monitoring system of claim 1, wherein:
at least one of the image capture devices and at least one of the audio capture devices are configured to cooperatively collect a video clip; and
the data analysis system is further configured to receive the video clip and sort the video clip by detecting one of the optical landmarks or one of the audio landmarks in the video clip.

18. The building monitoring system of claim 17, wherein:
when the video clip includes one of the optical landmarks, the data analysis system is further configured to extract images and sound from the video clip and sort the images and sound using the optical landmark; and
when the video clip includes one of the audio landmarks, the data analysis system is configured to extract images and sound from the video clip and sort the images and sound using the audio landmark.

19. A method of building monitoring, comprising:
receiving an image of a target building system from an image capture device, the image including a picture of the target building system and an optical landmark associated with the target building system;
identifying the target building system from the optical landmark;
extracting information about a first monitored aspect of the target building system from the image of the target building system; and
comparing the extracted information about the first monitored aspect of the target building system with previously extracted information about the first monitored aspect of the target building system from previously received images of the target building system.

20. The method of building monitoring of claim 19, further comprising:
receiving a sound clip of the target building system from an audio capture device, the sound clip including sound produced by the target building system and an audio landmark from an audio beacon proximate the target building system;
extracting information about a second monitored aspect of the target building system from the sound clip of the target building system; and
comparing the extracted information about the second monitored aspect of the target building system with previously extracted information about the second monitored aspect of the target building system from previously received sound clips of the target building system.
